(19) United States
(12) Patent Application Publication
(10) Pub. No.: US 2017/0071163 A1
(43) Pub. Date: Mar. 16, 2017

(54) Dog Leash With Sealable Compartment and Removable Bowl

(71) Applicant: Mirit M. Glasser, Montclair, NJ (US)

(72) Inventor: Mirit M. Glasser, Montclair, NJ (US)

(21) Appl. No.: 14/849,900

(22) Filed: Sep. 10, 2015

(51) Int. Cl. A01K 27/00; A01K 7/00; A01K 5/00

(52) U.S. Cl. CPC A01K 27/008; A01K 5/00; A01K 7/00; A01K 27/004

(57) ABSTRACT

A combination dispenser, bowl, and leash is disclosed herein which has a housing with a first hollow interior space, a bowl with a second hollow interior space, and a handle having a third hollow interior space there-in. The handle further forms a fourth hollow space between the housing and the handle. A leash extends into the third hollow space of the handle. The bowl can removably and sealably attach to the housing. The leash can be wound around the fourth hollow space and in the third hollow interior space. The first interior space of the housing can form a common spherical or ellipsoid border with the third hollow interior space. The first interior space can be formed from a cylinder with spherical cut there-in with extending spout. The spout can extend at least partially from a top side of the housing and open into the first interior space.

### FIELD OF THE DISCLOSED TECHNOLOGY

The disclosed technology relates generally to dog leashes and, more specifically, to dog leashes with sealable containers and bowls such as for food or liquid.

### BACKGROUND OF THE DISCLOSED TECHNOLOGY

When walking a dog (or other domestic animal), one often has to carry along certain essential items. Especially on long walks or hot days, a dog will become thirsty and will need to drink. Sources of water for the dog aren't readily available, or if they are, a receptacle for water is often out of reach. Similarly, one might decide to bring dog biscuits or other pet food, necessitating a receptacle to carry and set up same.

Combination devices have been made in the past, such as U.S. Pat. No. 7,789,042 to Dinon disclosing a pet leash and bowl, as well as patent publication 2011/0197820 to Goldy et al., disclosing a pet leash and different type of bowl. Still others have placed bowls directly into animal collars, such as in U.S. Pat. No. 8,613,262.

There is still room for upgrading the technology. What is needed is a method to more conveniently carry items for a dog on his daily walks.

### SUMMARY OF THE DISCLOSED TECHNOLOGY

A combination dispenser, bowl, and leash is disclosed herein which has a housing with a first hollow interior space, a bowl with a second hollow interior space, and a handle having a third hollow interior space there-in. The handle further forms a fourth hollow space between the housing and the handle. A leash extends into the third hollow space of the handle.

The bowl can be removably and sealably attached to the housing. The leash can be wound around the fourth hollow space and in the third hollow interior space. The first interior space of the housing can form a common spherical or ellipsoid border with the third hollow interior space. The first interior space can be geometrically formed from a cylinder with spherical cut there-in and a spout extending from a corner of the cylinder. The spout can extend at least partially from a top side of the housing and open into the first interior space. The bowl can be attached to a bottom side of the housing opposite the top side.

The bowl, in embodiments, has an exterior circumference identical to the housing. The leash, the third interior space, and the fourth space, can extend into the cylinder. The third interior space of the handle can have a portal through which the leash extends. The portal can open towards a bottom direction of the housing, the bottom direction defined by the aforementioned bottom side (that is, the bottom direction is the direction which goes from a top of the device towards the bottom side).

Another way of explaining the device is that it is a cylindrical container having a screw-off bowl and a first hollow interior region of the cylindrical housing separate from that of a hollow region created by the bowl. A ring handle extends from the housing with a second hollow interior region within the ring handle and the cylindrical container separate from the first hollow interior region. A leash can extend in a circular path defined by the second hollow interior region within the ring handle and the cylindrical container.

The first hollow interior region can have a solitary (single) opening into the first hollow interior region of the cylindrical housing at a side opposite the ring handle. A portal can be on the ring handle with the leash passing there-through. An exterior wall of the cylindrical housing, in embodiments of the disclosed technology, bends inwards in an elliptical manner corresponding to a wall of the second hollow interior region, such that the wall of the second hollow interior region is an exterior wall of the device. An inside and complete circular expanse of the ring handle forms an exterior (defined as, “open to the world”) of the device, in an embodiment of the disclosed technology.

Embodiments described with reference to the device of the disclosed technology are equally applicable to methods of use thereof.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1 shows a perspective view of a combination leash, bowl, and food dispenser of an embodiment of the disclosed technology.

FIG. 2 shows a side-elevation view thereof.

FIG. 3 shows an exploded perspective view thereof.

FIG. 4 shows an exploded side-elevation view thereof.

FIG. 5 shows a cutaway view thereof along a vertical axis.

### DETAILED DESCRIPTION OF EMBODIMENTS OF THE DISCLOSED TECHNOLOGY

A combination dispenser, bowl, and leash is disclosed herein which has a housing with a first hollow interior space, a bowl with a second hollow interior space, and a handle having a third hollow interior space there-in. The handle further forms a fourth hollow space between the housing and the handle. A leash extends into the third hollow space of the handle. The bowl can removably and sealably attach to the housing. The leash can be wound around the fourth hollow space and in the third hollow interior space. The first interior space of the housing can form a common spherical or ellipsoid border with the third hollow interior space. The first interior space can be geometrically formed from a cylinder with a spherical cut there-in and spout extending from a corner of the cylinder. The spout can extend at least partially from a top side of the housing and open into the first interior space. The bowl can be attached to a bottom side of the housing opposite the top side.

Embodiments of the disclosed technology will become clearer in view of the following description of the drawings.

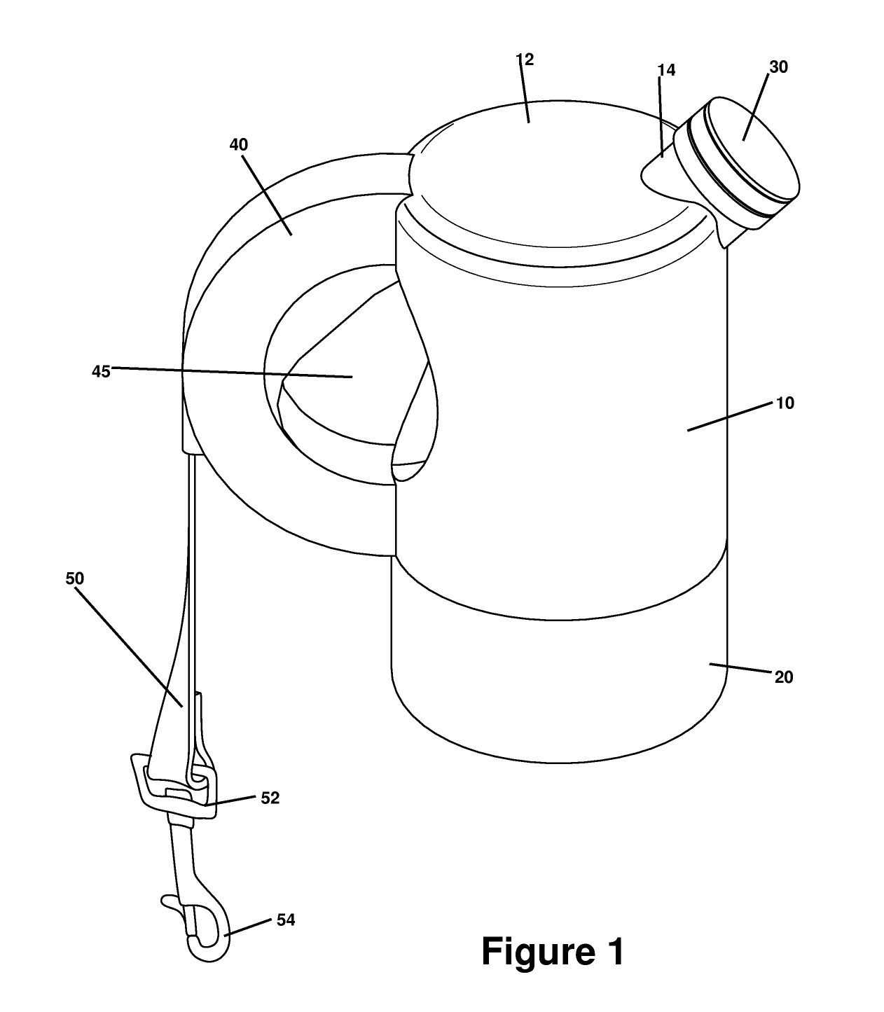

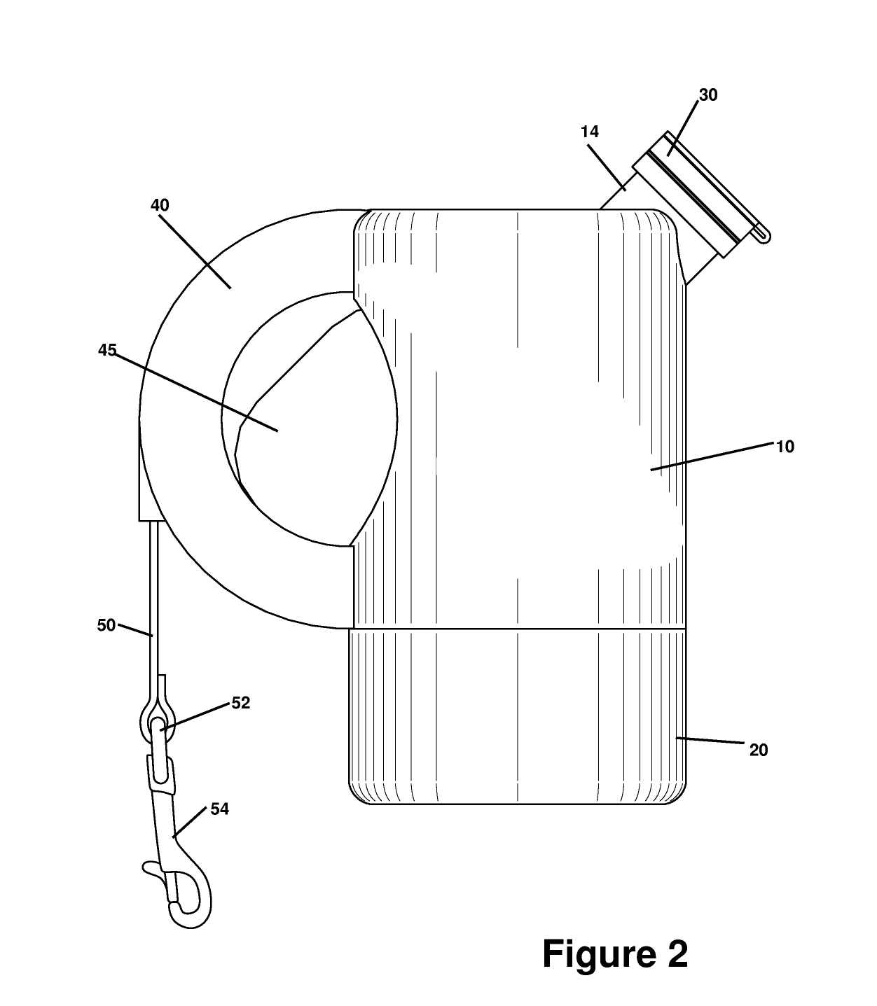

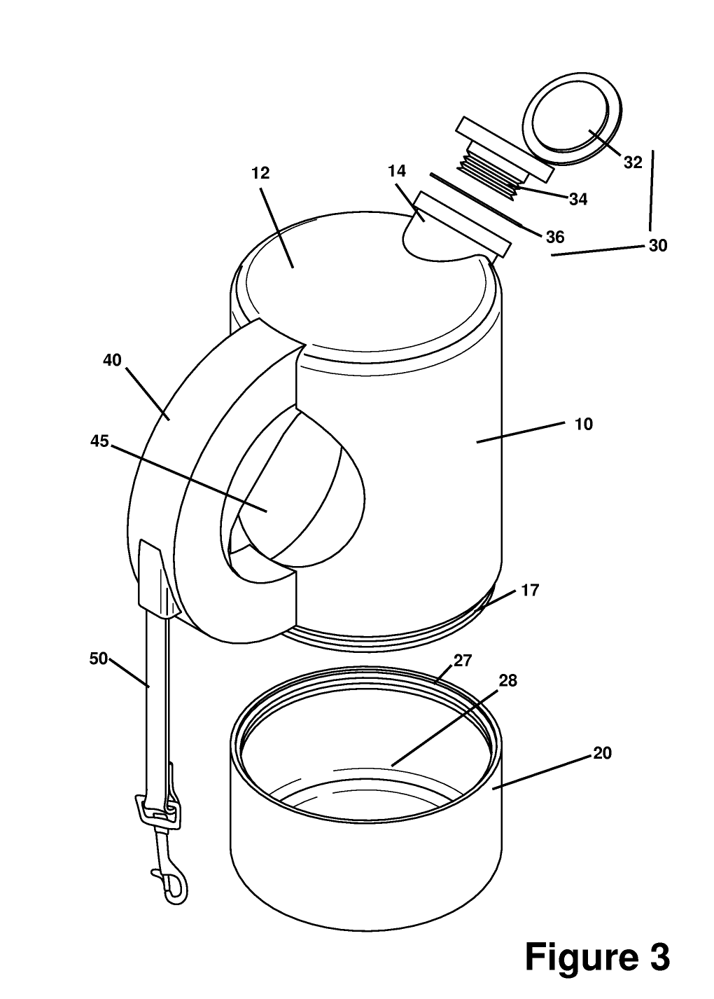

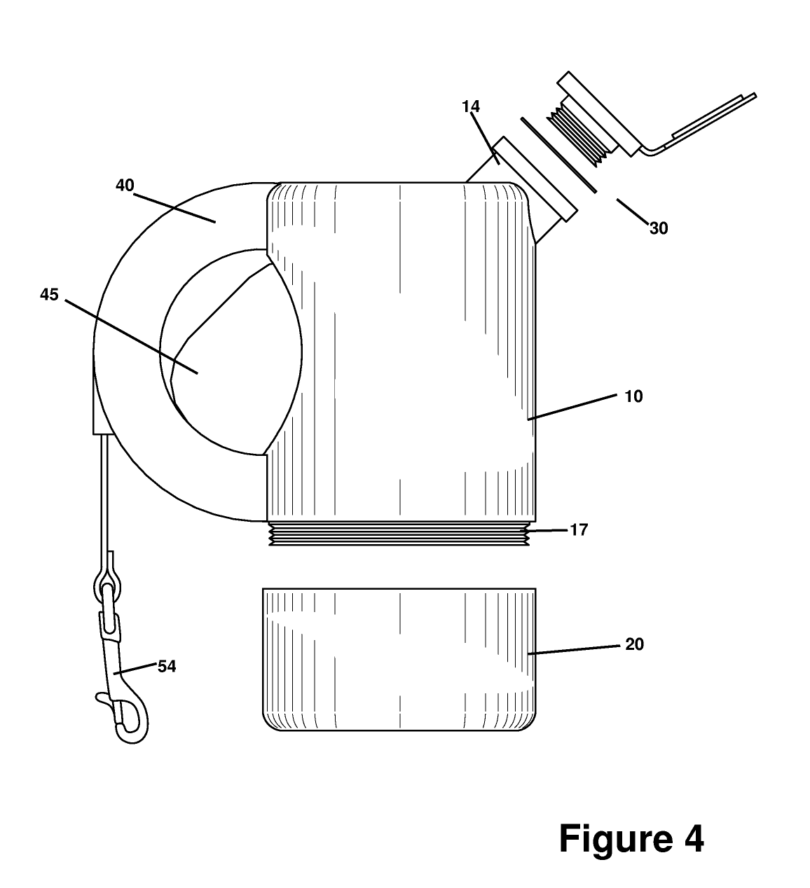

Discussing FIGS. 1 through 4 simultaneously, FIG. 1 shows a perspective view of a combination leash, bowl, and food dispenser of an embodiment of the disclosed technology. FIG. 2 shows a side-elevation view thereof. FIG. 3 shows an exploded perspective view thereof. FIG. 4 shows an exploded side-elevation view thereof. Here, a cylindrical housing 10 has a hollow interior with rectangular cross-section when cut vertically, as well as a rectangular cross-section with subtracted there-from an ellipse or circle when cut vertically along the handle 40. The opening or, in embodiments, the only opening, into the cylindrical housing 10 is by way of the spout 14 which rises out of the cylindrical housing, such as at a top side 12 and/or elongated side (the longest side of the cylindrical housing portion). A portal 30 extends from the spout 14, which has a sealable opening, into the cylindrical housing.

The handle 40 extends outward from, and connects to, the cylindrical housing, such as at two spaced-apart points. The handle, in embodiments of the disclosed technology, is circular or elliptical in shape and has a hollow interior. A portal and, in embodiments, a single solitary portal opens into the interior space of the handle which is circular or elliptical, the interior space also extending in the circular and/or elliptical manner into the body of the cylindrical region of the housing. This forms a portal 45 where one can place one's hand, between the ring handle 40 and the cylindrical housing 10 (the cylindrical housing being cylindrical except for, in embodiments of the disclosed technology, the continuation of the ring circular or elliptical ring handle “cutting” into the cylinder). A sphere or three dimensional ellipse is formed, in embodiments of the disclosed technology. between the cylindrical housing 10 and handle 40 having partial walls formed by the exterior extent of the cylindrical housing and interior extent of the handle. A button on the handle can be used to retract or lock the leash 50.

The leash 50 is a length of fabric, metal, or other malleable and bendable substance which exits from the (sole) portal of the handle 40 and can be retractable there-into the hollow space of the handle 40. The leash 50 has a connector 52 with locking mechanism 54 for attachment of a collar there-to.

As best shown in FIG. 3, the bowl 20 is detachable or removable from the cylindrical housing. The bowl 20 has an interior space 28 defined by its side and bottom wall and, in embodiments, has a circumference, or widest circumference, equal to that of the circumference, or widest circumference, of the cylindrical housing 10. A “circumference” is defined as “the distance around a circle or ellipse,” The bottom of the cylindrical housing 10 has, in an embodiment, a connector 17, such as threads. The connector 17 engages with a corresponding connector 27 of the bowl 20. The connectors can have the widest, or substantially widest, circumference of their respective housing and bowl and be equal to one another.

Still referring to FIG. 3, the portal 30 is shown with its respective parts blown apart—a sealable cap 32 covering an intermediate connector 34 which fits into an o-ring 36. The cap 32 can be fixedly attached to the intermediate connector, and the intermediate connector 34 can screw into threads of the spout 14. In this manner, a water-tight seal is created, in embodiments of the disclosed technology.

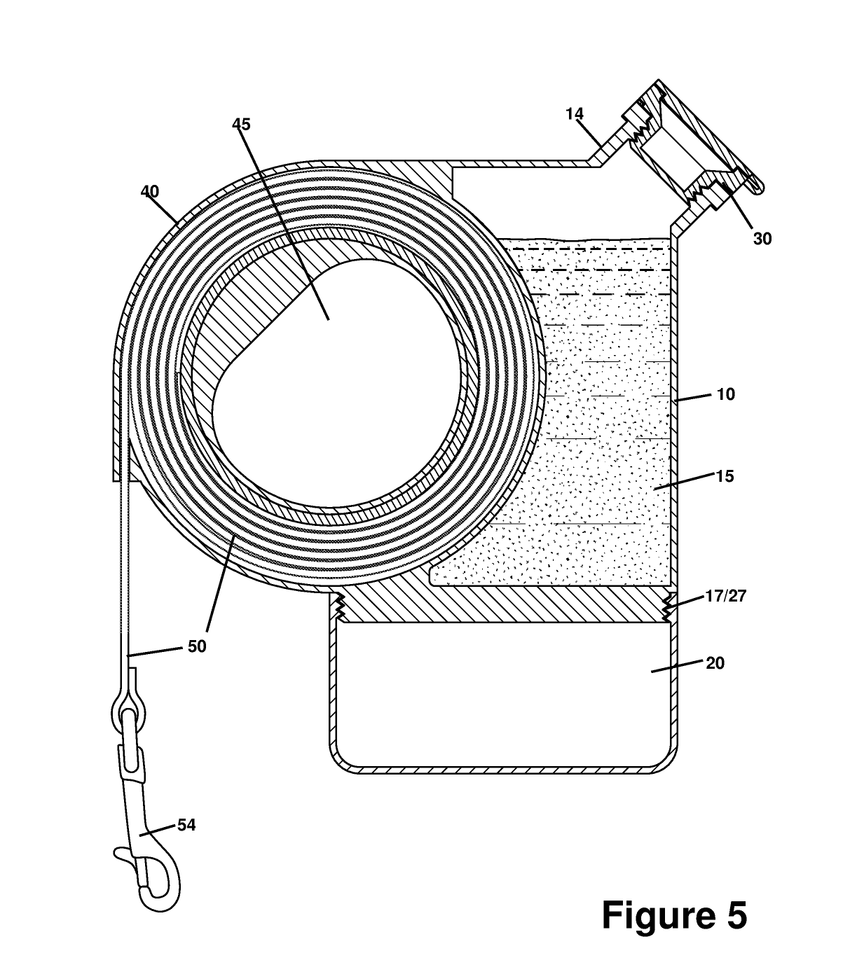

FIG. 5 shows a cutaway view of the items shown in FIG. 1, cut along a vertical axis. Here, the cut is along a central line of the spout 14, portal 30, and handle 40. In addition, it is therefore also along a central line of the housing 10 and bowl 20. The circular nature of the interior space of the handle 40 is clearly seen “cutting into,” or taking away from, the otherwise cylindrical nature of the housing 10, having an interior space 15 with liquid there-in. The leash 50 is wrapped around the hollow space 45 (spaced apart by the interior wall of the handle, between the hollow interior of the handle and hollow exterior space 45).

Thus, the cylindrical housing 10 actually has an interior space 15, in this embodiment, which has a rectangular cross-section minus, or missing there-from, a circular or elliptical region formed from the handle 40 and circular continuation thereof, as shown. The interior space 15 is further extended from the rectangular cross-section by another rectangular cross-section extending outward there-from in the form of a spout 14. In the embodiment shown, the spout 14 extends out from a corner of the device, but it could extend out from any side in other embodiments, such as from the top side or elongated/longest side wall.

The bowl 20, when connected by the connectors 17/27 which engage with each other, has side walls which form a unitary side wall with the housing 10, in embodiments of the disclosed technology. As such, a continuous rectangular cross-section (excepting for the handle/leash region and spout) is formed between the housing 10 and bowl 20. Referring now to FIG. 2, one can see that this has a “mug” appearance, defined as having a side handle, continuous, cylindrical exterior, except where cut into cylindrically and beneath the handle 40, and otherwise changed by a spout.

In this manner, four separate and distinct interior regions are created, three of which have one portal to the exterior world, and one of which has two portals to the exterior world. The cylindrical housing 10 has one spout 14 exiting to the exterior, which is closable and sealable by way of the portal 30. One can place water, as well as dog food, dog treats, or any other solid in the interior space 15 by way of the portal 30. The bowl 20 has a single portal on its top side which is accessible when disconnected from the housing 10. The side walls and bottom are closed, in embodiments of the disclosed technology. The handle 40 has an interior space which is circular, or substantially circular, in embodiments of the disclosed technology, except for in some embodiments, where a single portal breaks from the circular interior space. The single portal is the portal used for entry and exit of the leash. This covers the three interior regions which are distinct and separate from each other, each with only one portal which exits, or can exit, to the outside. The fourth interior region is the region 45 which has two portals opening to the outside of the device, though in embodiments, the openings are larger than the space contained by solid material. The solid material is the exterior side of the cylindrical housing 10 and the interior side of the handle 40 which face towards each other. On either side of this is a large portal.

In use, one can place a liquid or solid in the cylindrical housing 10 by way of the spout 14, and the seal likewise by way of the portal 30. One can then attach the bowl 20 to the cylindrical housing and an animal to the connector 54. The animal then pulls on the leash 50, and one walks the animal, or the like. Then, when desired, one disconnects the bowl 20 from the cylindrical housing 10 and opens the spout 14, pouring some or all of the solid and/or liquid contents held in the interior space 15 of the cylindrical housing 10 into the bowl 30. Then one can re-attach the bowl 20 to the cylindrical housing 10 and continue to walk the dog or other animal attached to the leash 50.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A combination dispenser, bowl, and leash comprising:
a housing with a first hollow interior space;
a bowl with a second hollow interior space;
a handle which has a third hollow interior space there-in and further forms a fourth hollow space between said housing and said handle;
a leash extending into said third hollow space of said handle.

2. The combination dispenser, bowl, and leash of claim 2, wherein said bowl removably and sealably attaches to said housing.

3. The combination dispenser, bowl, and leash of claim 3, wherein said leash is wound around said fourth hollow space and in said third hollow interior space.

4. The combination dispenser, bowl, and leash of claim 4, wherein said first interior space of said housing forms a common spherical or ellipsoid border with said third hollow interior space.

5. The combination dispenser, bowl, and leash of claim 4, wherein said first interior space is geometrically formed from a cylinder with spherical cut there-in and spout extending from a corner of said cylinder.

6. The combination dispenser, bowl, and leash of claim 5, wherein said spout extends at least partially from a top side of said housing and opens into said first interior space, and said bowl is attached to a bottom side of said housing opposite said top side.

7. The combination dispenser, bowl, and leash of claim 6, wherein said bowl has an identical exterior circumference to said housing.

8. The combination dispenser, bowl, and leash of claim 7, wherein said leash, said third interior space, and said fourth space, extend into said cylinder.

9. The combination dispenser, bowl, and leash of claim 7, wherein said third interior space of said handle has a portal through which said leash extends.

10. The combination dispenser, bowl, and leash of claim 9, wherein said portal opens towards the bottom direction of the housing, said bottom direction being defined by said bottom side.

11. A device comprising:
a cylindrical container having a screw-off bowl;
a first hollow interior region of said cylindrical housing separate from that of a hollow region created by said bowl;
a ring handle extending from said housing with a second hollow interior region within said ring handle and said cylindrical container separate from said first hollow interior region;
a leash extending in a circular path defined by said second hollow interior region within said ring handle and said cylindrical container.

12. The device of claim 11, further comprising a solitary opening into said first hollow interior region of said cylindrical housing at a side opposite said ring handle.

13. The device of claim 12, further comprising a portal on said ring handle with said leash passing there-through.

14. The device of claim 13, wherein an exterior wall of said cylindrical housing bends inwards in an elliptical manner corresponding to a wall of said second hollow interior region, such that said wall of said second hollow interior region is an exterior wall of said device.

15. The device of claim 13, wherein said inside and complete circular expanse of said ring handle forms an exterior of said device.

16. The device of claim 11, wherein said leash is retractable and a mechanism causing said retraction is in said ring handle.

17. The device claim 11, wherein said leash is non-retractable.
